(19) United States
(12) Patent Application Publication
(10) Pub. No.: US 2015/0152758 A1
(43) Pub. Date: Jun. 4, 2015

(54) Precision Lubrication of a Reciprocating Piston Within a Cylinder

(71) Applicant: EcoMotors, Inc., Allen Park, MI (US)

(72) Inventors: Peter Hofbauer, West Bloomfield, MI (US); Adrian Tusinean, Windsor (CA); Roger Budde, Chemnitz (DE); Ulrich Haubold, Oederan (DE); Matthias Krause, Chemnitz (DE)

(21) Appl. No.: 14/556,280

(22) Filed: Dec. 1, 2014

Related U.S. Application Data
(60) Provisional application No. 61/911,446, filed on Dec. 3, 2013.

(51) Int. Cl. F01M 11/02; F01M 1/16; F01M 1/08; F02F 3/00; F16J 9/00

(52) U.S. Cl. CPC F01M 11/02; F02F 3/0015; F16J 9/00; F01M 1/08; F01M 1/16; F01M 2011/022; F01M 2001/083

(57) ABSTRACT

Two-stroke engines are particularly prone to piston scuffing due to insufficient oil at some operating conditions. A system and method to precisely deliver oil is disclosed. An oil reservoir groove is formed in the piston with an oil reservoir ring welded to the surface of the piston. A cavity behind the ring forms an oil reservoir. The ring has an inlet gap. The cylinder wall has an oil injector installed therein which sprays oil into the inlet gap when the inlet gap is proximate the oil injector tip. An electronic control unit commands the quantity of oil to provide to the oil reservoir, with the quantity and timing of the injections based on the operating conditions of the engine.

### FIELD OF INVENTION

The present disclosure relates generally to lubricating the interface between a piston reciprocating within a cylinder.

### BACKGROUND

It is important to provide sufficient lubrication for piston reciprocating within a cylinder. In a four-stroke engine, extra lubricant can be splashed around to ensure there is sufficient lubrication on the cylinder liner or bore. Piston-ported two-strokes, however, are particularly prone to lubrication issues due to the tradeoff in providing enough oil for lubrication purposes while simultaneously preventing that oil from exiting the exhaust ports which leads to high oil consumption. Thus, precision lubrication in terms of quantity and coverage is desired.

Lubrication of the cylinder liner in a two-stroke engine is shown in commonly-assigned, published application, US 2010/0050978, filed 27 Aug. 2009. An inertia reactive oil injector in the piston, in one embodiment, has a tunnel passage and reservoir formed beneath the side surface of a piston. One or more strategically-placed oil reservoirs are provided within the piston. An outlet in the sidewall of the piston allows the mass of the oil within the reservoir(s) to force itself through the outlet in reaction to the deceleration of the piston when it approaches its TDC position. Lubricating oil enters the inlet port, the reservoir, and the tunnel passage during exposure to the pressurized oil below the oil seal. It is desirable to provide a way to fill the reservoir in a controllable manner.

The oil reservoir disclosed in US 2010/0050978 may be challenging to manufacture. An alternative manufacturing approach to provide a reservoir in the piston is desired.

### SUMMARY

According to an embodiment of the present disclosure, an oil injector is provided to inject oil into the reservoir. The oil injector is electronically coupled to an electronic control unit to control the oil injection quantity and frequency as desired.

To overcome at least one problem in the prior art, a piston-and-cylinder assembly for an internal combustion engine includes: a piston having a crown and a skirt with an outer surface of the crown and outer surface of the skirt forming a substantially cylindrical surface of the piston. The cylindrical surface of the piston has a compression ring groove and an annular oil distribution reservoir defined therein; a compression ring situated in the compression ring groove with the compression ring unattached to the piston; and an oil reservoir ring situated in the oil reservoir groove with the oil reservoir ring fixed to the piston.

In one embodiment, the compression ring groove and the oil reservoir groove are formed circumferentially into the outside surface of the skirt of the piston. The oil reservoir ring has an inlet gap. The oil reservoir ring is affixed to the cylindrical surface at an upper edge of the reservoir ring and at a lower edge of the reservoir ring.

The oil delivery passages have an inlet port at the oil reservoir and an outlet port at the cylindrical surface. The outlet ports are located closer to the piston crown than the inlet ports. The oil reservoir ring has an inlet gap. The piston is adapted to reciprocate within the cylinder wall between a top center position and a bottom center position. The assembly further includes an injector disposed through the cylinder wall and aimed at the inlet gap when the piston is at the bottom center position. In an alternative embodiment, such as a piston that was 3-D printed, the oil reservoir is formed in the piston skirt, i.e., no groove is formed in the side of the skirt. No oil reservoir ring is provided. Instead a hole from the outside of the piston skirt to the oil reservoir is provided for the injector to supply oil to the oil reservoir.

The assembly may further include an engine position sensor and an electronic control unit (ECU) electronically coupled to the injector and the engine position sensor. The ECU commands the injector to open based at least on engine position. In some embodiments, the assembly further include: a heater associated with the injector to raise temperature of oil within the injector and an electronic control unit (ECU) electronically coupled to the heater. The ECU commands the heater to turn on prior to a cold start of the engine.

In some embodiments, the crown and the skirt are integrally formed. In some embodiments, one or more of the grooves are formed in the crown and one or more of the grooves are formed in the skirt. The cylindrical surface of the piston is made up of the cylindrical outer surface of the crown and the cylindrical outer surface of the skirt.

Alternatively, an internal combustion engine is disclosed that includes: a cylinder wall and a piston disposed within the cylinder wall and adapted to reciprocate within the cylinder wall between a top center position and a bottom center position. The piston has a crown and a skirt with an outer portion of the crown and an outer portion of the skirt forming a substantially cylindrical surface of the piston. The surface is substantially cylindrical because as well known by one skilled in the art, a piston may be slightly barrel shaped or may be slightly oblong to account for uneven expansion, and may have features in the surface such as an opening for a wrist pin and grooves to accommodate ring. The cylindrical surface has a compression ring groove and an annular oil distribution reservoir defined therein. The annular oil distribution reservoir has at least one outward opening. A compression ring is situated in the compression ring groove. An oil injector is situated in the cylinder wall and located so that the oil injector is aligned with the outward opening of the annular oil distribution reservoir when the piston is proximate a predetermined position. In at least one embodiment, the predetermined position is the bottom center position.

The annular oil distribution reservoir is a groove formed in the cylindrical surface of the piston. In some embodiments, the groove is a reentrant groove. An oil reservoir ring is disposed in the groove. An upper edge of the oil reservoir ring is affixed to the upper edge of the groove. A lower edge of the oil reservoir ring is affixed to the lower edge of the groove. The oil reservoir ring has at least one circumferential gap, i.e., the outward opening. A plurality of oil distribution passages are defined in the piston with the passages extending between the annular oil distribution reservoir proximate the crown and the cylindrical surface of the piston. The oil distribution passages are angled toward the crown as considered from the annular oil distribution reservoir to the outer surface of the piston.

When the engine is mounted in a vehicle such that the cylinder wall is oriented at an angle displaced from the vertical such as in horizontal and vee engines, the outward opening of the annular oil distribution reservoir is located substantially at the highest point of the annular oil reservoir groove as mounted in the vehicle.

The engine also includes an electronic control unit (ECU) electronically coupled to the oil injector. The ECU commands a timing and pulse width to the oil injector.

The engine may further include a heater coupled to the injector and an electronic control unit electronically coupled to the heater.

In some embodiments, surfaces of the annular oil distribution reservoir are coated with a non-wetting coating.

Also disclosed is a method to provide oil to the cylinder wall of an internal combustion engine, including: providing a piston having a crown and skirt with a cylindrical outer surface of the piston having an annular oil distribution reservoir that has an outward opening; installing the piston within the cylinder wall; providing an oil injector in the cylinder wall with a tip of the oil injector aimed at the outward opening of the oil distribution reservoir; providing oil delivery passages having inlets at the annular oil distribution reservoir and outlets at an outer surface of the piston; and commanding the oil injector to open when the outward opening of the annular, reentrant oil distribution reservoir is aligned with the oil injector. The method further includes: placing an oil reservoir ring in the outer portion of the oil distribution reservoir. A gap in the oil reservoir ring is the outward opening. An upper edge of the oil reservoir ring is affixed to an upper edge of the annular, reentrant oil distribution reservoir. A lower edge of the oil reservoir ring is affixed to a lower edge of the annular, reentrant oil distribution reservoir.

The piston is adapted to reciprocate between a top center position and a bottom center position. The oil injector is located so that the outward opening of the distribution reservoir is aligned with the injector when the piston is at the bottom center position.

### BRIEF DESCRIPTION OF THE DRAWINGS

FIG. 1 is a cross-sectional representations of a piston with an annular oil distribution reservoir;

FIGS. 2 and 3 are cross-sectional illustrations of a portion of the piston in FIG. 1;

FIG. 4 is a cross-sectional representation of a portion of a piston in which the annular oil distribution reservoir is formed in the inner surface of the piston skirt;

FIGS. 5 and 6 are cross-sectional representations of portions of a piston in which the annular oil distribution reservoir is cast within the piston;

FIGS. 7 and 8 are cross-sectional representations of portions of a piston in which the annular oil distribution according to embodiments of the present disclosure;

FIGS. 9-11 are cross-sectional representations of the piston of FIG. 1 with the cross section taken perpendicular to the central axis of the piston; and

FIG. 12 is a schematic representation of a piston within a cylinder and components associated with an oil injection system.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

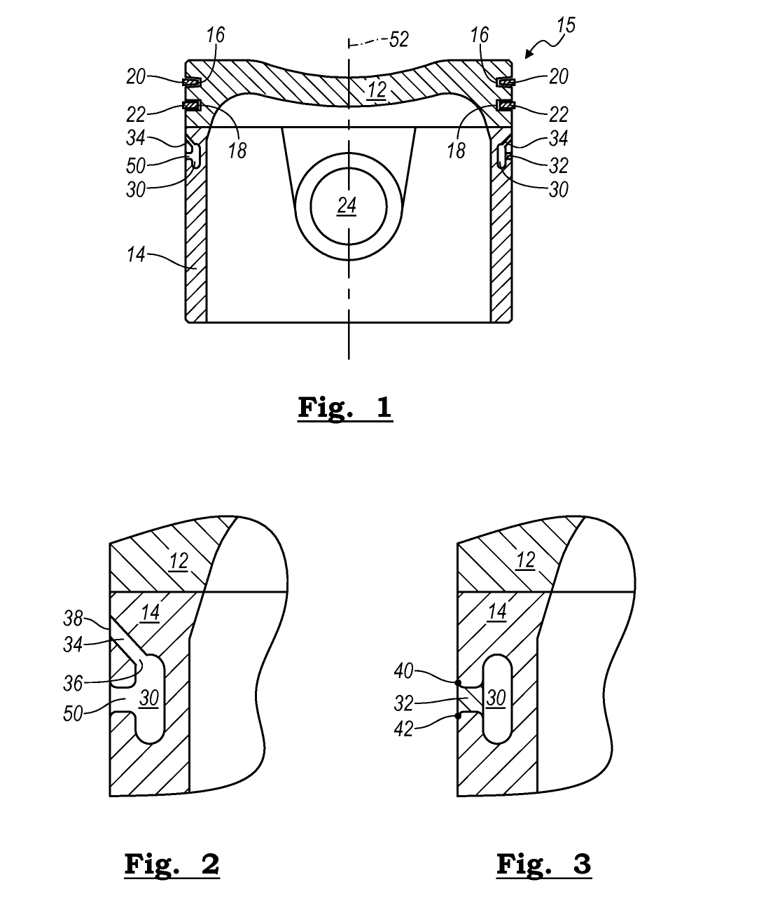

A piston 15 having a crown 12 and skirt 14 is shown in cross section in FIG. 1. Crown 12 is affixed to skirt 14 by welding, friction welding, bolting together, or any suitable method. The piston in FIG. 1 shows a piston crown that is separately formed from the piston skirt and then assembled. Alternatively, the piston is a single piece with the crown and the skirt formed as one integral piece. Groove 16 and 18 are formed in crown 12. A keystone compression ring 20 is disposed in groove 16; a compression ring 22 is disposed in groove 18. Piston 15 has an opening 24 to support a wrist pin.

Piston 15 also has an annular oil distribution reservoir 30 defined in skirt 14. Annular oil distribution reservoir 30 has an oil reservoir ring 32 installed in the outward opening of annular oil distribution reservoir 30, except for at least one location in which an outward opening 50 remains unobstructed. Annular oil distribution reservoir 30 has a plurality of delivery passages 34 that extend from reservoir 30 to the outer surface of skirt 14.

A detail of a portion of piston 15 is shown in FIG. 2. The cross section in FIG. 2 is through outward opening 50 and through a delivery passage 34. Delivery passage 34 has an inlet port 36 within reservoir 30 and an outlet port 38 at the outer surface of skirt 14. In FIG. 3, a detail of a portion of piston 15 shows a cross section through oil reservoir ring 32. In the embodiment shown in FIG. 3, an upper edge of oil reservoir ring 32 is welded to an upper edge of the opening in piston skirt 14 and a lower edge of oil reservoir ring is welded to a lower edge of the opening in piston skirt 14. Weld beads 40 and 42 are upper and lower weld beads, respectively.

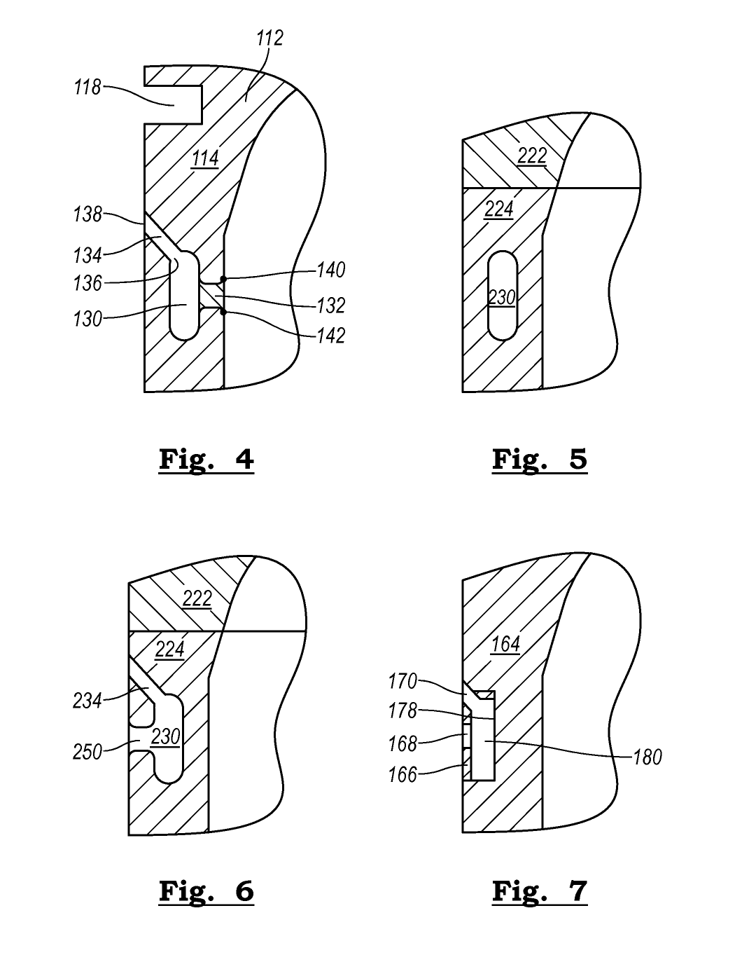

In FIGS. 1-3, annular oil reservoir 30 is formed with an opening at the outside surface of piston skirt 14. Alternatively, an annular oil reservoir 130 is formed in an inner surface of piston skirt 114 as illustrated in a cross-sectional view in FIG. 4. An oil reservoir 130 has a ring 132 fitted in the opening and welded to piston skirt 114 at weld beads 140 and 142. The cross section in FIG. 4 intersects an oil delivery passage 134 that has an inlet port 136 and an outlet port 138. The portion of the piston shown in FIG. 4 is one in which the crown 112 and the skirt 114 are integrally formed.

In FIGS. 1-4, an annular oil reservoir is shown with an opening in the inner or outer surface of the skirt. However, an annular oil reservoir 230 formed in during the casting of skirt 224 is shown in FIG. 5. FIG. 6 shows the skirt of FIG. 5 with an outward opening 250 and an oil delivery passage 234 machined into skirt 224.

The annular oil reservoirs 30 in FIGS. 1-3 and 130 in FIG. 4 is a reentrant groove. This may prove to be a challenge to machine into the cylindrical surface of the piston. An embodiment in which the groove is not reentrant is shown in FIG. 7. Groove 178 is formed in the cylindrical surface of piston 164. An oil reservoir ring 166 is installed in groove 178. An annular oil reservoir 180 is defined by groove 178 and oil reservoir ring 166. An outward opening 168 is defined in oil reservoir ring 166. As will be described below, an oil injector is provided to inject oil through outward opening 168 to provide oil to oil reservoir 180. This may be one opening around the periphery or more. A delivery passage 170 is defined in oil reservoir ring 166. A plurality of such delivery passages may be arranged around the periphery of oil reservoir ring 166.

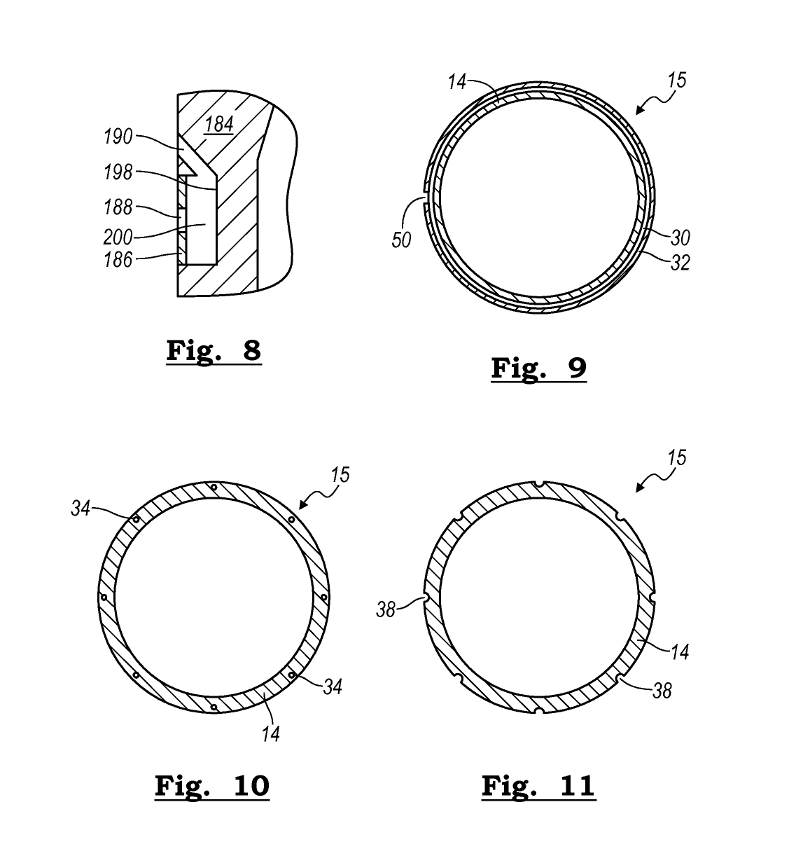

In another embodiment shown in FIG. 8, a groove 198 is formed in the cylindrical surface of piston 184. An annular oil reservoir 200 is defined by groove 198 and an oil reservoir ring 180 that is installed into the outer edge of groove 198. In this embodiment, delivery passages are defined in piston 184 with an inlet at oil reservoir 200 and an outlet at the surface of the piston.

A cross section that is perpendicular to a central axis 52 of piston 15 of FIG. 1 is shown in FIG. 9. The cross section in FIG. 9 is taken through oil reservoir ring 32 and annular oil reservoir 30. Oil reservoir ring 32 has an outward opening 50. Alternatively, oil reservoir ring may have a plurality of outward openings. The cross section in FIG. 10 is taken closer to the piston crown and through oil delivery passages 34. In the non-limiting example in FIG. 10, there are eight evenly space oil delivery passages 34. The cross section in FIG. 11 is taken through the outlet ports 38.

The embodiments described above show a piston crown and a piston skirt with the compression rings defined in the crown portion of the piston and the annular oil distribution reservoir defined in the skirt. However, in other embodiments, one or more of the compression rings are defined in the piston skirt. In yet other embodiments, the annular oil distribution reservoir is defined in the crown. To describe all these combinations, the grooves may be described as being defined in the outer cylindrical surface of the piston, with the outer cylindrical surface being made up of an outer surface of the crown and an outer surface of the skirt.

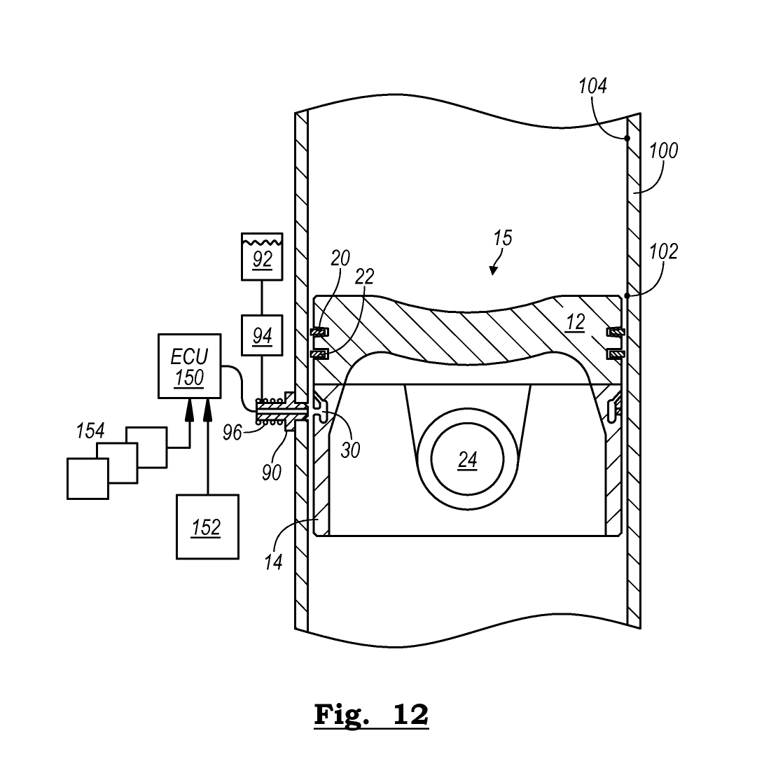

Referring now to FIG. 12, piston 15 is shown disposed in a cylinder wall 100. Piston 15 is shown at its bottom center position in which the top of piston 15 is at position 102 in cylinder wall 100. Piston 15 has a cranktrain (not shown) that causes piston 15 to reciprocate between position 102, the bottom center position, and position 104, the top center position.

An oil injector 90 pierces through cylinder wall 100. Injector 90 is supplied oil from an oil reservoir 92 and pressurized by a pump 94. An electronic control unit (ECU) 150 is electronically coupled to injector 90 to command an injection by causing the injector to open and deliver oil. ECU 150 commands oil injector 90 to inject when oil injector 90 is aligned at the outward opening to annular oil reservoir 30. In the embodiment in FIG. 12, this occurs when piston 15 is in its bottom center position. In alternative embodiments, it could occur at a different time.

A heating coil 96 is shown on the outside of oil injector 90 in FIG. 12. At cold start, the oil in oil injector 90 and the supply lines may be colder than desirable for the desired lubrication. Heating coil 96 is one non-limiting example. Alternatively, a heater within oil injector could be provided, such as an inductive heater. In yet another embodiment, engine coolant is heated prior to engine start. If the block is heated in this manner, oil injector and its contents, may also be heated.

ECU 150 is electronically coupled to a position sensor 152 and other sensors 154, such as temperature and pressure sensors. A signal from position sensor 152 can be used by ECU 150 to time injector 90 to provide oil when the outward opening (50 in FIGS. 1 and 2) is in the proper position to allow oil to be collected in annular oil reservoir 30.

As the piston moves toward top center, acceleration of the piston causes the oil to be pressed into the lower portion of annular oil reservoir 30. When the piston nears top center and the acceleration of the piston is downward, the oil is pressed into the upper portion of annular oil reservoir 30 causing the oil to be delivered to cylinder wall 100 through delivery passages. FIG. 12 is insufficiently detailed to show the delivery passages; but these are shown as element 34 in FIG. 1.

In some embodiments, the annular oil reservoir and/or the inside surface of the oil reservoir ring may be coated with an anti-wetting coating. By doing so, the amount of oil in the reservoir is less affected by the amount that adheres to reservoir surfaces.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A piston-and-cylinder assembly for an internal combustion engine, comprising:
a piston having a crown and a skirt with an outer surface of the crown and an outer surface of the skirt forming a substantially cylindrical surface of the piston, a circumferential compression ring groove and an annular oil reservoir defined in the cylindrical surface of the piston;
a compression ring situated in the compression ring groove with the compression ring unattached to the piston; and
an oil reservoir ring situated in the oil reservoir groove with the oil reservoir ring fixed to the piston.

2. The piston-and-cylinder assembly of claim 1 wherein:
the oil reservoir ring has an inlet gap; and
the oil reservoir ring is affixed to the skirt at an upper edge of the reservoir ring and at a lower edge of the reservoir ring.

3. The piston-and-cylinder assembly of claim 2, further comprising:
delivery passages defined in the piston wherein:
the oil delivery passages have an inlet port at the oil reservoir and an outlet port at the cylindrical surface of the piston; and
the outlet ports are located closer to the crown than the inlet ports.

4. The piston-and-cylinder assembly of claim 1 wherein the oil reservoir ring has an inlet gap and the piston is adapted to reciprocate within the cylinder wall between a top center position and a bottom center position, the assembly further comprising:
an injector disposed through the cylinder wall and aimed at the inlet gap when the piston is at the bottom center position.

5. The piston-and-cylinder assembly of claim 4, further comprising:
an engine position sensor; and
an electronic control unit (ECU) electronically coupled to the injector and the engine position sensor wherein the ECU commands the injector to open based at least on engine position.

6. The piston-and-cylinder assembly of claim 1, further comprising:
a heater associated with the injector to raise temperature of oil within the injector; and
an electronic control unit (ECU) electronically coupled to the heater wherein the ECU commands the heater to turn on prior to a cold start of the engine.

7. An internal combustion engine, comprising;
a cylinder wall;
an oil injector disposed in the cylinder wall;
a piston disposed within the cylinder wall and adapted to reciprocate within the cylinder wall between a top center position and a bottom center position wherein:
the piston has a crown and a skirt with an outer surface of the crown and an outer surface of the skirt forming a substantially cylindrical surface of the piston;
the cylindrical surface of the piston has a compression ring groove defined therein;
the piston skirt has an annular oil distribution reservoir defined therein;
the annular oil distribution reservoir has at least one outward opening;
a compression ring is situated in the compression ring groove; and
the oil injector is located so that the oil injector is aligned with the outward opening of the annular oil distribution reservoir when the piston is proximate a predetermined position.

8. The internal combustion engine of claim 7 wherein the predetermined position is a bottom center position of piston travel.

9. The internal combustion engine of claim 7 wherein the annular oil distribution reservoir is a groove formed in the cylindrical surface of the piston, the engine further comprising:
an oil reservoir ring disposed in the groove, wherein:
an upper edge of the oil reservoir ring is affixed to the upper edge of the groove;
a lower edge of the oil reservoir ring is affixed to the lower edge of the groove; and
the oil reservoir ring has at least one circumferential gap that comprises the at least one outward opening.

10. The internal combustion engine of claim 7 wherein the annular oil distribution reservoir is a groove formed in the inner surface of the skirt, the engine further comprising:
an oil reservoir ring disposed in the groove, wherein:
an upper edge of the oil reservoir ring is affixed to the upper edge of the groove; and
a lower edge of the oil reservoir ring is affixed to the lower edge of the groove.

11. The internal combustion engine of claim 7, further comprising:
a plurality of oil distribution passages defined in the piston, the passages extending between an end of the annular oil distribution reservoir proximate the crown and the cylindrical surface of the piston.

12. The internal combustion engine of claim 11 wherein the oil distribution passages are angled toward the crown as considered from the annular oil distribution reservoir to the cylindrical surface of the piston.

13. The internal combustion engine of claim 11 wherein there are at least six oil delivery passages distributed around the circumference of the piston skirt.

14. The internal combustion engine of claim 7 wherein when the engine is mounted in a vehicle such that the cylinder wall is oriented at an angle displaced from the vertical such as in horizontal and vee engines, the outward opening of the annular oil distribution reservoir is located substantially at the highest point of the annular oil reservoir groove as mounted in the vehicle.

15. The internal combustion engine of claim 7, further comprising:
an electronic control unit (ECU) electronically coupled to the oil injector wherein the ECU commands a timing and pulse width to the oil injector.

16. The internal combustion engine of claim 7, further comprising:
a heater coupled to the injector; and
an electronic control unit (ECU) electronically coupled to the heater.

17. The internal combustion engine of claim 7 wherein surfaces of the annular oil distribution reservoir are coated with a non-wetting coating.

18. A method to provide oil to the cylinder wall of an internal combustion engine, comprising:
providing a piston having a crown and skirt with a cylindrical surface of the piston being made up of an outer surface of the crown and an outer surface of the skirt;
forming an annular oil distribution reservoir in the cylindrical surface of the piston wherein the annular oil distribution reservoir has at least one outward opening;
installing the piston within the cylinder wall;
providing an oil injector in the cylinder wall with a tip of the oil injector aimed at the outward opening;
providing oil delivery passages having inlets at the annular oil distribution reservoir and outlets at an outer surface of the piston; and
commanding the oil injector to open when the outward opening of the annular oil distribution reservoir is aligned with the oil injector.

19. The method of claim 18 wherein the annular oil distribution reservoir is formed in the outer surface of the skirt, the method further comprising:
placing an oil reservoir ring in the outer portion of the annular oil distribution reservoir wherein a gap in the oil reservoir ring comprises the outward opening;
affixing an upper edge of the oil reservoir ring to an upper edge of the annular oil distribution reservoir; and
affixing a lower edge of the oil reservoir ring to a lower edge of the annular oil distribution reservoir.

20. The method of claim 18 wherein the piston is adapted to reciprocate between a top center position and a bottom center position and the oil injector is located so that the outward opening of the annular oil distribution reservoir is aligned with the injector when the piston is at the bottom center position.
